(19) United States
(12) Patent Application Publication
(10) Pub. No.: US 2026/0008484 A1
(43) Pub. Date: Jan. 8, 2026

(54) LOCKING DEVICE FOR MANUALLY RELEASING A PARKING BRAKE

(71) Applicant: KB Intellectual Property GmbH & Co. KG, Pullach (DE)

(72) Inventors: Ferdinand HECHT, Weichs (DE); Michael Mathieu, Schondorf am Ammersee (DE); André Stegmann, Eichenau (DE); Mar-Gregory Elstorpff, Muenchen (DE)

(21) Appl. No.: 19/240,557

(22) Filed: Jun. 17, 2025

(30) Foreign Application Priority Data
Jul. 5, 2024 (DE) 10 2024 119 194.5

(51) Int. Cl. B61H 13/04; B60T 13/36; B60T 17/08; B60T 17/16

(52) U.S. Cl. CPC B61H 13/04; B60T 17/085; B60T 17/16; B60T 13/365

(57) ABSTRACT

A locking device configured to manually release a parking brake in a brake actuator for rail vehicles, the locking device including a spindle drive including a teething; a locking element engaging the teething of the spindle drive and switching a rotating movement and thus an axial force transmission of a parking brake on or off; and at least one contact damping element configured to dampen or prevent a contact of the locking element.

### RELATED APPLICATIONS

This application claims priority from and incorporates by reference German patent application DE 10 2024 119 194.5, filed on Jul. 5, 2024.

### FIELD OF THE INVENTION

The invention relates to a locking device for manually releasing a parking brake, and a brake actuator, including the locking device.

### BACKGROUND OF THE INVENTION

A generic locking device in a parking brake is disclosed in DE 10 2018 122 519 A1. This is a brake cylinder with mechanical brake force locking. The parking brake described herein secures the vehicle against unintentional roll-off, provides permanent establishment of the required locking force, facilitates activating and deactivating different driver cabs along the train, and manual deactivation by an emergency release of the parking brake when losing the regular actuation energy.

Another generic embodiment of the parking brake is the so-called spring accumulator parking brake as described, e.g. in DE 10 2007 063 699 B4. This is a passive brake. This means that the parking brake force is generated by a spring when the parking brake is actuated. The spring accumulator piston is loaded with pressure, and the spring is pre-loaded in order to release the parking brake. In case no pressure is available, the parking brake can be released manually, wherein the force transfer has to be interrupted by using blocking elements.

Thus, either the entire parking brake force, or only a portion of the parking brake force reduced by a transmission, impacts locking elements configured, e.g. as locking catches. In order to initiate the release process, a friction force caused by the parking brake force has to be overcome.

This reduces the friction force during release process when transitioning from static friction to dynamic friction. On the other hand, a portion of the clamping energy is transferred to the locking elements when rapidly releasing the parking brake force and the clamping energy. This causes a significant acceleration of the locking elements, so that the locking elements subsequently impact contact surfaces with a large amount of energy. This loads the locking elements and the contact surfaces heavily, which causes a substantial amount of noise.

EP 2 826 684 B1 also discloses a locking device with a gear that is unlockable by a locking catch, wherein high forces are transferred from the locking catch to the contact surfaces during unlocking, which causes a substantial amount of noise for the same reasons.

### BRIEF SUMMARY OF THE INVENTION

Thus, it is an object of the invention to provide a locking device that reduces the problems recited supra, thus a reduction in the development of a high level of noise and large forces impacting the contact surfaces.

The object is achieved by a locking device A locking device configured to manually release a parking brake in a brake actuator for rail vehicles, the locking device including a spindle drive including a teething; a locking element engaging the teething of the spindle drive and switching a rotating movement and thus an axial force transmission of a parking brake on or off; and at least one contact damping element configured to dampen or prevent a contact of the locking element.

The locking device according to the invention manually releases a parking brake which is arranged, in particular, in a brake actuator of a rail vehicle. The locking device may include a spindle drive including teething, and at least one locking element switching the rotating movement and thus the axial force transmission of the parking brake. This locking element is advantageously configured as a pivotable locking catch.

The locking catch engages the teething. The teething can advantageously include one or plural asymmetrical teeth and/or tooth notches. The locking device, according to the invention includes at least one contact-damping element which dampens or prevents a contact of the locking element, in particular, at a housing of the brake actuator.

The contact damping element prevents the generation of noises and reduces a risk of mechanically damaging the locking catch and the contact surfaces at the housing.

Advantageous embodiments of the invention are described in the dependent claims.

In an advantageous embodiment that can be assembled in a few steps, the contact damping element is configured as an elastic damping element.

The contact damping element can be alternatively and advantageously configured in a compact configuration as a fluid damper with a gaseous and/or liquid damping medium.

In another advantageous embodiment, the contact damping element can include a friction surface at a contact surface towards the locking catch. Released kinetic energy is partially converted into heat at this location.

The embodiments recited supra can be combined in one contact damping element or can be used in a combination of several damping elements to dampen a single or plural locking catches.

In advantageous embodiments, the locking device, advantageously, the contact damping element, can include a spring-loaded pin which presses the locking catch into engagement with the teething of the spindle drive under an impact of a reset force of the spring of the spring-loaded pin. This coupling variant can be implemented with rather little installation space required, so that a particularly large amount of space becomes available for arranging one or plural contact damping elements.

The locking catch can be activatable by a locking bar that is displaceable on a linear path and that is associated with a control device. This option of unlocking without large force impact facilitates decoupling the locking catch in a gradual process without jolts.

In this context, it is particularly advantageous when the locking catch includes a contact roller which is arranged relative to the locking bar, so that the locking roller is configured to roll along a sloped contact surface of the locking bar in order to activate the locking catch. Due to the rolling, no large initial force has to be applied to overcome friction resistance.

The contact damping element can be advantageously fixed in a receiver of the locking catch. This embodiment facilitates a preassembly of the contact damping element at the locking catch before mounting the locking catch in the housing, which substantially simplifies assembly.

In an embodiment of the invention that can be assembled particularly easily, the contact damping element includes a mushroom head with a contact surface and a shaft, configured to be locked in the receiver of the locking bar and/or in a receiver of the housing.

Advantageously, the contact damping element can be made from an elastomeric material and/or a TPE, at least in portions, in particular, in an area of the mushroom head.

Particularly advantageously, the contact damping element is configured from several components, wherein the contact damping element is made from a material at least in portions, in particular, in an area of the shaft, wherein the material has a greater elasticity modulus than a material in an area of the mushroom head. The material with the smaller elasticity modulus is more flexible and, therefore, deformable more easily.

The locking device can additionally include a component which includes the spring-loaded locking pin that is configured as the contact damping element, which yields a particularly compact configuration.

In particular, the component can include a pressure cavity adjacent to the spring-loaded pin, wherein a damping medium is arranged in the pressure cavity.

Thus, it is advantageous when the spring-loaded pin has an end with a bolthead that tapers into a point and includes the friction surface.

The locking catch is divided into a first lever arm and a second lever arm, wherein the control device impacts the first lever arm. The second lever arm engages a corresponding teething of the spindle drive, in particular, a threaded nut of the spindle drive, with a teething that includes at least one tooth. At least the first lever arm is advantageously configured with bending flexibility in order to facilitate optimized decoupling of the teething. Bending flexibility in this context means a resilience in a range of 1×10⁻⁵ to 1×10⁻² 1/N under standard conditions like e.g. 25 degrees Centigrade.

In another embodiment of the invention, a brake actuator is provided, in particular, for a rail vehicle, including a parking brake and a locking device according to the invention, configured to release the locking device.

The locking device according to the invention can be used in a plurality of brakes. Particularly advantageously, the locking device according to the invention can be used in rail vehicles.

In an advantageous embodiment of a service actuator according to the invention, the parking brake can include an axially movable sevice brake piston that is movable by pressure application and that is coupled with a piston tube of the spindle drive. The piston tube engages a threaded nut of the spindle drive of the locking device according to the invention, wherein the threaded nut is rotatably supported in the housing and includes the teething. The locking device according to the invention cooperates with the teething of the threaded nut through the locking catch. The locking catch is pivotable towards a surface provided at the housing when releasing the engagement with the threaded nut. The surface is subsequently also designated as contact surface. However, the contact damping element can impact the locking element, in particular, the locking catch, so that a contact at the contact surface can also be prevented.

In another advantageous embodiment the brake actuator according to the invention can be configured as a combination brake cylinder. The brake actuator includes a service brake cylinder as an active service brake, including at least one pressure medium actuated service brake piston which actuates a brake mechanism through a service brake piston rod. The combination brake cylinder additionally includes a spring accumulator brake cylinder, configured as part of the passive parking brake, wherein the spring accumulator brake cylinder is releasable by the locking device and provided with a pressure medium-actuated spring accumulator brake piston, wherein the pressure medium counteracts the effect of the at least one accumulator spring, wherein the spring accumulator piston transfers a force of the at least one accumulator spring to the service piston rod when the parking brake is actuated. Thus, this variant of the brake actuator essentially corresponds to the embodiments described in DE 10 2007 063 699 B4, with the difference being that the brake locking device according to the invention is provided in this brake actuator.

Alternatively, the contact damping element can be fixed in the wall of a housing of the brake actuator. In case the engaging forces mechanically damage the locking catch, the contact damping element can remain in the housing in spite of replacing the locking catch.

### BRIEF DESCRIPTION OF THE DRAWINGS

Additional advantages, features, and details of the invention can be derived from the subsequent description of plural embodiments of the invention with reference to appended drawing figures. A person skilled in the art will advantageously use the features provided in the drawings, in the description and in the claims in combination and combine the features into additional advantageous combinations, wherein:

FIG. 1 illustrates a schematic partial view of a locking device of a brake actuator according to the invention;

FIG. 2 illustrates a blown-up view of a damping element configured to dampen a contact of a locking catch of the locking device;

FIGS. 3A-C illustrate a detailed view of plural additional variants of damping elements configured to be used in a brake actuator according to the invention, which differs from FIG. 2;

FIG. 4 illustrates a detail view of a second embodiment of a damping element of a locking device according to the invention;

FIG. 5 illustrates a detail view of a third variant of a damping element of a locking device according to the invention;

FIG. 6 illustrates a second embodiment of a locking device of a second brake actuator according to the invention; and

FIG. 7 illustrates a third variant of a locking device of a third brake actuator according to the invention.

### DETAILED ESCRIPTION OF THE INVENTION

Several variants of brake actuators with parking brakes, e.g. of rail vehicles, are known in the art. Generic combinations of the parking brake besides the locking device can be derived from DE 10 2018 122 519 A1 or DE 10 2007 063 699 B4, which are incorporated in their entirety by this reference.

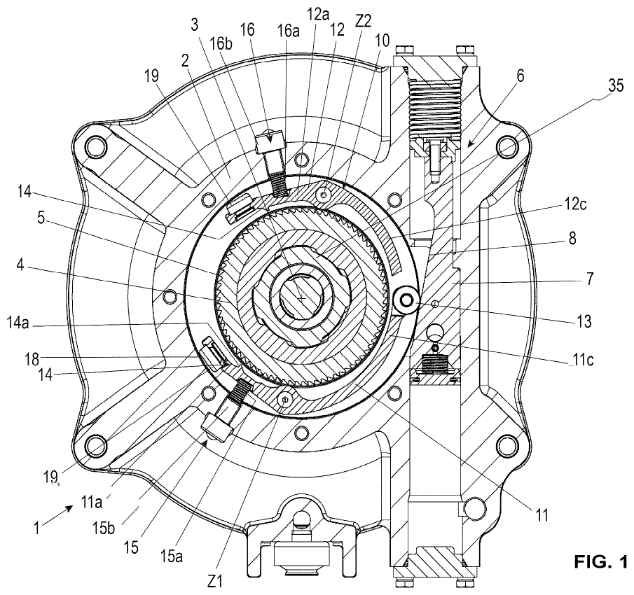

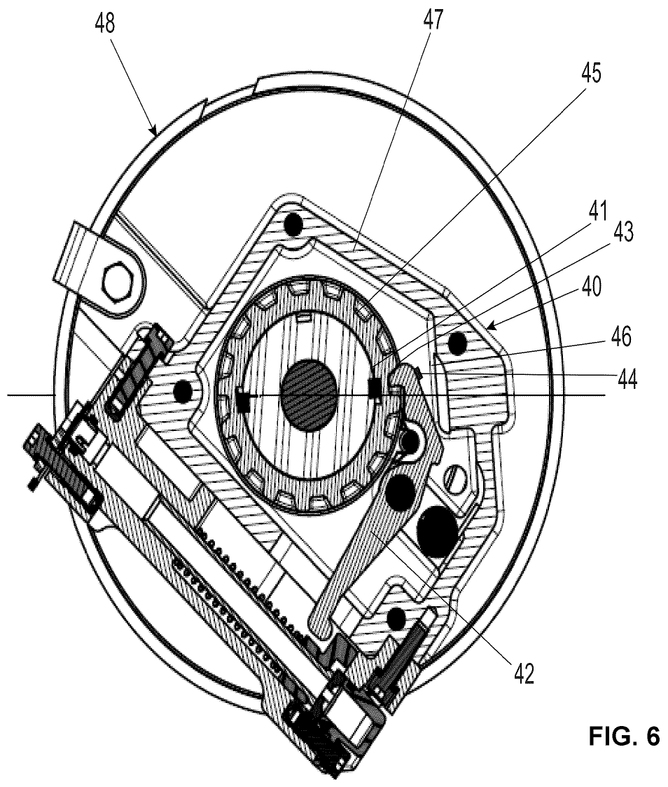

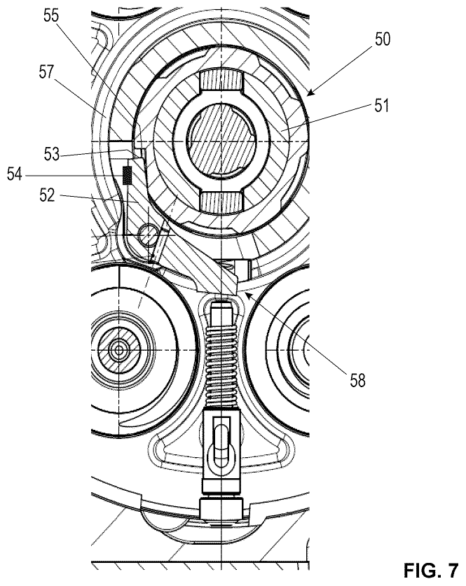

The basic configuration of a first embodiment of the brake actuator 1 according to the invention, including the parking brake, is illustrated with reference to FIG. 1, wherein the locking device according to the invention can be used in the brake actuator. Using the locking device, however, is not limited to this configuration of a brake and a brake actuator. A second and a third embodiment of a brake actuator are illustrated in FIGS. 6 and 7. Numerous other embodiments of brake actuators can be implemented within the spirit and scope of the instant invention.

A brake actuator 1 typically includes a parking brake. The parking brake includes a locking device which functions as a mechanical brake force locking device and which is configured for applications in rail vehicles. The interior of the housing 1a of the parking brake typically includes a service brake piston that is displaceable along a piston axis. The service brake piston can divide the housing into a pressure cavity and the interior of the housing recited supra. The pressure cavity is typically loaded with a pressure medium, e.g. compressed air. The service brake piston is connected with the piston rod through a piston tube. The piston rod transfers a brake force upon a brake linkage of a rail vehicle when braking is performed. The piston tube recited supra includes a thread which engages a threaded nut 4. The threaded nut 4 is part of a spindle drive 35. The thread is not configured self-locking. The threaded nut 4 is rotatably supported in the associated section of the housing, rotatable about the piston axis 3 and fixed axially. An axial movement of the service brake piston and the piston tube towards the piston axis 3 causes a rotation of the threaded nut 4 about the piston axis 3 due to the non-self-locking thread engagement with the threaded nut 4. When the rotation of the threaded nut 4 is impeded by locking, the axial movement of the service brake piston is locked as well. This locking is implemented by the locking device 10 that cooperates with an outer teething 5 of the threaded nut 4.

The locking device 10 illustrated in FIG. 1 includes the threaded nut 4, a first locking catch 11, a second locking catch 12, and a control device in the illustrated embodiment.

The locking catches 11, 12 form locking elements that are arranged radially opposed with reference to the piston axis 3, wherein the threaded nut 4 is arranged coaxial to the piston axis 3. In another embodiment, a single locking catch can be provided. The locking catch 11 additionally includes a contact roller 13. Portions of the locking catch 12 are arranged e.g. behind the locking catch 11 in FIG. 1. Therefore, FIG. 1 only shows a portion of the locking catch 12. The locking catch 12 can also include a contact roller that is covered by the contact roller 13.

The locking catches 11 and 12 cooperate with the teething 8 of the threaded nut 4 and are actuated by the control device. The control device includes a locking bar 7 with an inclined contact surface 8, wherein the contact roller 13 of the locking catch 11 and optionally also the contact roller of the locking catch 12 roll on the inclined contact surface. The locking bar 7 is moveable on a linear path perpendicular to the piston axis 3 and can be moved manually, by pressure, by an electric motor, or any other manner.

The contact roller 13 of the locking bar 11 rolling along the inclined contact surface 16 causes a pivot movement of the locking bar 11 about a pivot axis, so that a teething of the locking bar 11 can be brought into engagement with the teething 8 of the threaded nut 4 or brought out of engagement. As illustrated in the instant embodiment, the teething 14 can include only one tooth 14a. The locking bar does not have to have a tooth. It can be inserted into a tooth gap of the spindle drive only with a lever portion, e.g., a face, so that the spindle drive is blocked in one direction of rotation.

The pivot axes Z1 and Z2 of the locking catches 11 and 12 are thus arranged parallel to the rotation axis 3 of the spindle drive 35.

The locking catches 11, 12 are configured as angle levers with two lever arms 11a, 11c and 12a, 12c, respectively. Thus, the locking catches 11, 12 reach around the radially circumferentially teething of the threaded nut 4 by more than 180 degrees. The teething 8 of the locking catch 11 is part of the first lever arm 11a, and the contact roller 13 is part of the second lever arm 11c. The lever arm 11c, including the contact roller 13 that is subsequently also designated as roll side lever arm 11c, is configured longer than the lever arm 11a with the teething 14.

When engaged, the teething 14 with the associated teeth in the embodiment illustrated in FIG. 1 provides positive form locking, like e.g. in a locking arrangement. The teething 8 and 14 can thus be configured with a saw tooth profile. Particularly advantageously, the teething 8 is configured so that each tooth includes a radial flank and an inclined flank with reference to the piston axis 3. When the locking device 10 is in a locked condition, the respective radial flanks of the teething 14 are in contact with radial flanks of the teething 8.

Additionally, the housing 1a includes a spring retainer 15, 16. Thus, teethings 14 of the locking catches 11, 12 are pressed into engagement with the teething 8 of the threaded nut 4 respectively by a spring 15a, 16a. The springs 15a, 16a are respectively configured as compression springs and respectively contact the lever arm 11c and 12c of the locking catches 11, 12 with a spring-loaded pin 15b, 16b of the spring retainers 15, 16. Thus, the spring force of the spring 15a impacts the second lever arm 11c of the first locking catch 11 so that the first locking catch 11 is pivoted clockwise about its pivot axis Z1 so that the threaded nut 4 is engaged. The spring force of the spring 16a works in a similar manner.

It is thus evident from FIG. 1 that linear movement of the locking bar 7 causes a radial pivoting of the lever arm 11c away from the piston axis 3, so that the lever arm 11c contacts a contact surface of the housing 1a in an end position of the lever arm 11c.

The friction force that gradually decreases during the release process e.g. due to a transition from static friction to dynamic friction and due to the instantaneous reduction of the parking brake force and the clamping energy during the release of the engagement a portion of the clamping energy is transferred to the locking elements, thus the locking catches 11 and 12. This causes a substantial acceleration of the locking elements, which subsequently impact the contact surfaces 18 of the housing 1a with high energy. This loads the locking catches 11, 12 as well as the contact surfaces 11 substantially, so that a considerable amount of noise is generated.

In order to avoid this situation, the lever arms 11c and 12c of the locking elements or of the locking catches 11, 12 include one or plural contact damping elements 19 advantageously made from an elastomeric material or a TPE material. Particularly advantageously, these contact damping elements can be configured as rubber grommets.

On the other hand, the locking elements are made from metal, e.g. steel.

The contact damping elements 19 are arranged at an end of the lever arm 11c and connected therewith by positive form locking.

The material of the contact damping elements 19 has a lower elasticity modulus, advantageously at least five times lower than the material of the locking elements. The contact damping element 19 protrudes from the surface of the locking catch 11 or 12 on a side oriented away from the threaded nut 4. The protrusion can amount to at least fifty percent of the height of the locking catch 11, 12 adjacent to the contact damping element 19.

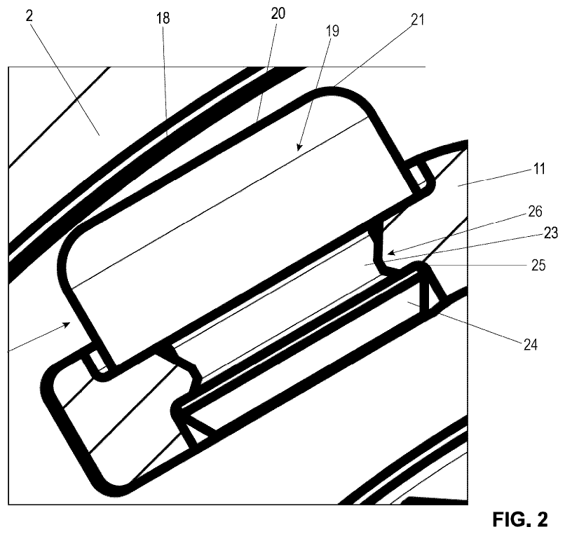

FIG. 2 shows a blown-up view of the contact damping element 19 of FIG. 1, showing a flat contact surface, advantageously with rounded edges 21. The contact surface 20 is part of a mushroom head 22 which transitions into a shaft in an opposite direction to the contact surface 20 and which terminates in a cantilevered base 24. The base is configured conical in order to facilitate insertion into a receiver 26 of the locking catch 11. The base 24 corresponds to an undercut 25 of the receiver 26 of the locking catch 11 and thus forms positive form locking engagement with the receiver 26 of the locking catch 11, so that a positive form locking and blocking of the contact damping element 19 against a linear movement in or against the insertion direction is provided. Advantageously, the contact damping element 19 is symmetrical, particularly advantageously axial symmetrical, in particular rotation symmetrical.

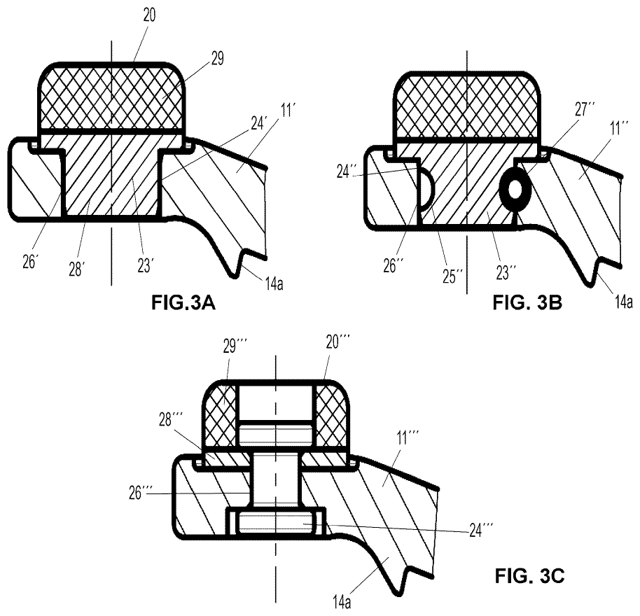

FIGS. 3A-C show embodiments of fixing a contact damping element in a receiver 26′, 26″, 26′″ of a locking catch 11′, 11″, 11′″. All other elements of the locking device can be configured identical to FIG. 1.

The contact damping element 19′ of FIG. 3A also includes a mushroom head 22′ with a contact surface 20′. The shaft 23′ adjacent to the mushroom head 22′ includes an enveloping surface 24′ without protrusions protruding from the enveloping surface. The contact damping element 19 is supported by a press fit in the receiver 26′ of the locking catch 11 at an identical position as shown in FIG. 2. The contact damping element 19′ includes a combination of two materials. The mushroom head 22′ is made from the same elastic material recited supra, e.g., an elastomeric material or a TPE in an area of the contact surface 20′.

At least the shaft 23′ and, advantageously, also a portion of the mushroom head 22′ oriented away from the contact surface 20′ can be advantageously configured from a material with a larger elasticity module than the elastic material of the mushroom head 22′ in an area of the contact surface 20′. The elastic material of the mushroom head 22′ forms a contact element 29′. The material with the greater elasticity modulus forms a support element 28′. This facilitates improved anchoring of the contact damping element 19′ in the receiver 26′. The contact damping element 19′ is advantageously configured symmetrical as well, particularly advantageously, axial symmetrical and, in particular, rotation symmetrical.

The contact damping element 19″ of FIG. 3B is configured analogous to FIG. 3A besides the shape of the shaft 23″. The shaft 23″ includes a recess 25″ in the enveloping surface 24″. A flexible clamping element 27″ or a locking pin is arranged in the recess 25″ between the contact damping element 19″ and the receiver 26″ of the locking catch 11″. This clamping element 27″ can deform when inserting the contact damping element 19″ into the receiver 26″ and blocks the linear movement of the contact damping element 19′ in or against the insertion direction until a force is reached where the clamping element 27″ is being deformed. The clamping element 27″ can be partially or entirely circumferential about the shaft 23″. The clamping element 27″ can be optionally associated with the receiver 26″ or the contact damping element 19″.

The contact damping element 19′″ of FIG. 3C includes a shaft that is configured as a component that is separate from the mushroom head 22′″. This can be a bolt-nut combination with a screw that is insertable on the mushroom head side and with a flat nut as a corresponding fixing element which facilitates a locking against a linear movement in or against the insertion direction. The contact surface 20″ is interrupted by a component receiver 24′″. In analogy to the preceding embodiments, the mushroom head is configured from a stop element 29′″ made from an elastic material and an annular disc shaped carrier element 28′″ that has a greater elasticity modulus than the elastic material. Instead of the bolt and the flat nut, also other mechanical connectors 24′″, e.g. a locking sleeve with two annular discs at respective ends is conceivable. Therefore, the separate component does not have to be configured as a bolt-nut combination. The separate component can also have any shaft section and two stop elements arranged at an end of the shaft section. This can also be implemented by a riveted connection.

The component receiver 24′″ in the mushroom head 22′″ can function as a receiving space for the elastic deformation of the elastic material. This facilitates even greater deformation of the mushroom head with the same acceleration towards the stop.

According to FIGS. 3A-C, the stop element 29′, 29′″ being an elastomeric material can also be vulcanized onto the carrier element 28′, 28′″ configured as a metal component. Thus, the carrier element 28, 28′″ can be connected with the locking catch 11, 11′, 11″, 11′″ in various ways, e.g. through a press fit, form locking, or a riveted connection.

The contact damping elements 19, 19′, 19″, 19′″ that are illustrated in FIGS. 1-3 are configured to convert a kinetic energy of the locking catches 11, 11′, 11″, 11′″ into heat or friction energy.

The contact damping elements described supra are configured elastic, in order to provide additional deformation travel. Since the energy is an integral of distance times force, the additional deformation distance for the same energy causes a reduction of the force at the contact surfaces and a reduction of the noise generation.

Additionally, the elastic deformation of the locking elements provides a spring elastic “post-travel”. When the locking elements are configured rotatable, like the locking catches recited supra, this means that the mass moment of inertia does not impact the stop surfaces of the housing 1a abruptly, but with a time delay due to the additional deformation travel. These in turn cause a reduction of the contact force in the contact point and thus a reduction of the noise development.

It is also evident from FIG. 1 that the lever arm on the roller side 11c is quite delicate and thus easy to bend, at least configured easier to bend than the other lever arm 11a with the teething 14. As described supra, this has the effect that the arm covers an additional rotation angle and thus travels an additional deformation path as soon as the locking catch 11, 11′, 11″, 11′″ impacts a stop during release. Thus, the contact force at the contact damping elements 19, 19′, 19″, 19′″ is reduced additionally. The locking catches 11, 11′, 11″, 11′″ and their associated lever arms 11a and 11b have low bending resistance when their resiliency is in a range of 1×10⁻⁵ und 1×10⁻² 1/N under standard measuring conditions.

The resiliency of the locking catches is defined by the quotient of bending travel divided by the bending torque, defining the locking catch arm as a cantilever bar, the resiliency δ is computed as follows:

$$δ = \frac{{l}^{2}}{3 \times E \times I}$$

In the illustrated embodiments, the resiliency is provided directly in the locking catch which is configured as an integral component in one piece. It is also conceivable, however, that the resiliency is implemented by a multi-piece locking element in that the locking catch is configured, e.g. in two components and with an additional spring element like a leaf spring or a coil spring.

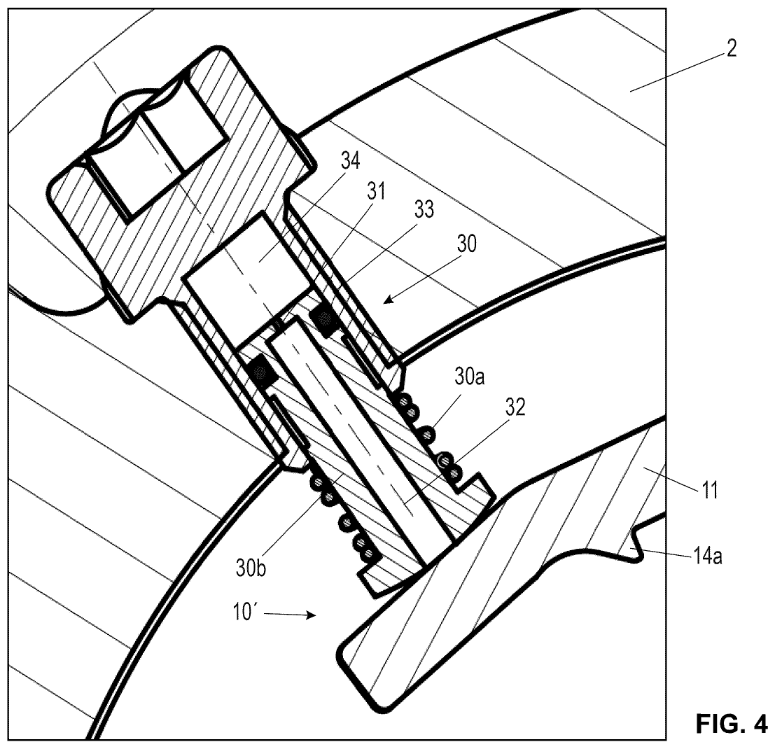

Another embodiment of the locking device 10′ according to the invention is illustrated in FIG. 4. Thus, the respective spring retainers 15 and 16 of FIG. 1 are configured as fluid dampers 30. Thus, the contact damping element and the spring retainer 15, 16 are implemented in one component. The fluid damper can be configured as a pneumatic damper or a hydraulic damper. It also includes a spring 30a and a spring-loaded pin 30b.

In the case of the pneumatic damper illustrated in FIG. 4, the compressed air can escape through a nozzle or orifice 31. The nozzle 31 facilitates a transition of air into a center borehole 32 into the spring-loaded pin 30. The spring retainer 15, 16 is respectively arranged in the wall of the housing 1a by a housing sleeve 33, e.g. a threaded sleeve. The spring-loaded pin 30 is supported displaceable on a linear path in the housing sleeve 33. A pressure chamber 34 is arranged beyond the spring-loaded pin 30b, wherein liquid or gaseous pressure fluid can escape from the pressure chamber through the nozzle 31 and the borehole 32 due to a corresponding compression pressure.

The spring-loaded pin 30b includes a seal at an edge, wherein the seal seals the spring-loaded pin 30b when moved relative to the housing sleeve 33.

The configuration of the spring retainer 15, 16 described supra facilitates a conversion of kinetic energy into heat and/or a delayed flow of the damping fluid through the borehole 32 and the viscosity of the fluid dampens the transfer of the kinetic energy. This in turn reduces the contact forces. As recited supra, embodiments with liquid damping fluid like, e.g. oil or similar, are conceivable and advantageous.

In another advantageous embodiment of the invention, the locking device 10″ can be configured with an alternative variant of a damping element which combines a spring retainer and an elastically deformable contact damping element.

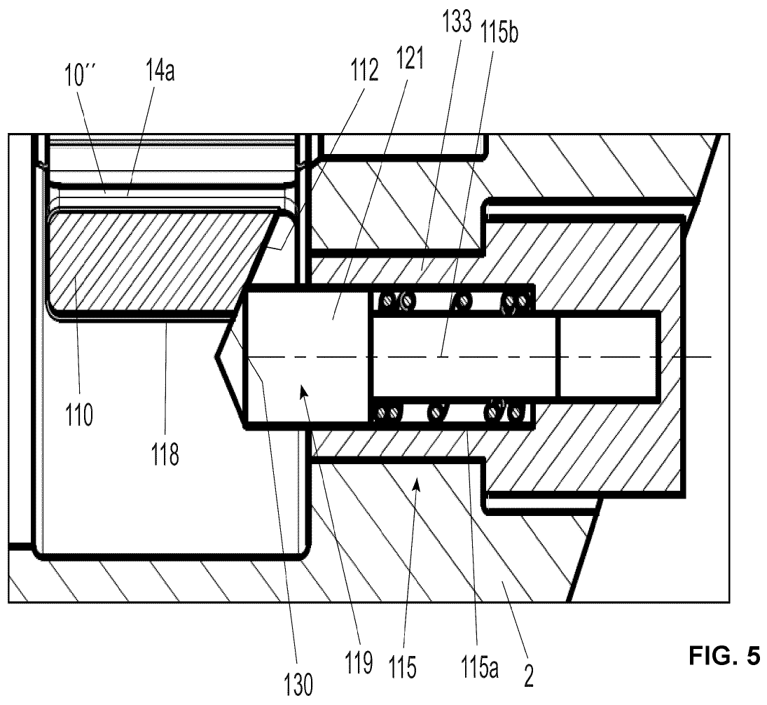

FIG. 5 illustrates a view of the locking device 10″ that is rotated by 90 degrees compared to FIG. 1, so that the viewing direction is along the longitudinal extension of the locking catch 110.

The locking catch 110 includes a slanted surface at an edge of its contact surface 118, wherein a bolthead 121 that is spring loaded and tapers into a point is configured to slide along the slanted surface 112.

The bolthead 121 is part of a spring retainer 115 that is configured as a contact damping element 119. The bolthead 121 is an end piece of a spring retainer 115 that is spring supported by a spring 115a. The contact damping element additionally includes a housing sleeve 133 that is arranged in the wall of the housing 1a.

An end surface of the bolthead 121 is configured as a friction surface 130 which is configured to generate friction along the slanted surface 112. The spring-loaded pin 115b is pressed against the slanted surface 112 in an unloaded condition of the locking catch 110 so that the locking catch 110 comes into engagement with the threaded nut 44.

When the locking catch 110 is actuated by the control device 13 and pivoted, the spring-loaded pin 115b is pressed deeper into the housing sleeve 133 while compressing the spring 115a.

The friction of the friction surface 130 along the slanted surface 112 or the wedge surface increases the damping effect.

The solution shown in FIG. 5 thus includes plural friction elements engaging the locking catch.

Thus, kinetic energy of the locking element is partially converted into friction energy and thus heat. The slanted surface 112 increases the friction force, which dissipates additional energy. Also this embodiment reduces the force upon the contact surfaces and thus noise development.

Embodiments of the figures can be modified in many ways without departing from the spirit and scope of the invention. Thus, the bolthead 121 of FIG. 5 may not include a center tip, but a tip arranged at the edge so that the friction surface 130 is increased in size.

Additionally, also several of the recited contact damping elements can be provided in one locking device.

The locking device according to the invention can be used in plural configurations of brake actuators with parking brakes, e.g. also in spring accumulator parking brakes.

FIG. 6 shows another embodiment of a locking device 40 according to the invention, including a spindle drive 41 with a teething 45, in particular, a circumferential external teething or a radial teething. Analogous to the embodiment in FIG. 1, the teething 45 engages a locking element associated with the locking device 40 and is configured as a locking catch 42 that is arranged pivotable about a pivot point. The locking catch 42 includes a tooth 43 at a side oriented towards the teething 45 and includes an elastic damping element 44 on an opposite side of the locking catch 42. The elastic damping element dampens a contact of the locking catch at the contact surface 46 of the housing 47 of the brake actuator 48.

FIG. 7 shows another variant of a locking device 50 with a spindle drive 51 with a teething 45. In this case, the teething 45 is merely a single tooth notch. This also represents a teething according to the instant invention.

The teething 55 additionally includes an engagement with an edge 53 of the locking catch 52 that is arranged pivotable about a pivot point. The engagement is provided in this case by interlocking of the teething and the edge merely by a contact of the flank of the tooth notch against the edge 53 of the locking catch 52.

The locking catch 52 also includes an elastic damping element 54. The elastic damping element 54 dampens the contact of the locking catch 52 at the housing 57 of the brake actuator 58.

The teething 5, 45, and 55 of the spindle drive is advantageously configured as an asymmetrical teething in the embodiments of FIGS. 1-7.

### REFERENCE NUMERALS AND DESIGNATIONS

1 brake actuator
1a housing
2 housing
3 rotation axis
4 threaded nut
5 teething
6 control device
7 locking bar
8 sloped contact surface
10, 10′, 10″ locking device
11, 11′ 11″ 11′″ locking catch
11a lever arm
11c lever arm
12, 12′ 12″, 12′″ locking catch
12a lever arm
12c lever arm
13 contact roller
14 teething
14a tooth
15 spring retainer
15a spring
15b spring-loaded pin
16 spring retainer
16a spring
16b spring-loaded pin
18 contact surface
19, 19′, 19″, 19′″ contact damping element
20, 20′, 20′″ contact surface
21 rounded area
22, 22′, 22′″ mushroom head
23, 23′, 23″ shaft
24 base
25 undercut
26, 26′, 26″, 26′″ receiver
24′, 24″ enveloping surface
25″ recess
27″ clamping element
28′ 28′″ support element
29′, 29′″ contact element
24′″ mechanical connector
30 fluid damper/contact damping element
30a spring
30b spring-loaded pin
31 nozzle
32 borehole
33 housing sleeve
34 pressure chamber
35 spindle drive
40 locking device
41 spindle drive
42 locking catch
43 tooth
44 damping element
45 teething
46 contact surface
47 housing
48 brake actuator
50 locking device
51 spindle drive
52 locking catch
53 edge
54 damping element
55 teething element
57 housing
58 brake actuator
110 locking catch
112 slanted surface
115 spring retainer
115a spring
115b spring-loaded pin
118 contact surface
119 contact damping element
121 bolthead
130 friction surface
133 housing sleeve
Z1, Z2 pivot axis

What is claimed is:

1. A locking device configured to manually release a parking brake in a brake actuator for rail vehicles, the locking device comprising:
a spindle drive including a teething;
at least one locking element engaging the teething of the spindle drive and switching a rotating movement and thus an axial force transmission of a parking brake on or off; and
at least one contact damping element configured to dampen or prevent a contact of the at least one locking element.

2. The locking device according to claim 1, wherein the at least one locking element is configured as a pivotable locking catch.

3. The locking device according to claim 1, wherein the at least one contact damping element is configured as an elastic damping element.

4. The locking device according to claim 1, wherein the at least one contact damping element is configured as a fluid damper with a gaseous and/or liquid damping medium.

5. The locking device according to claim 2, wherein the at least one contact damping element includes a friction surface in a contact area for the pivotable locking catch.

6. The locking device according to claim 2, further comprising: a spring-loaded pin that presses the pivotable locking catch into engagement with the teething of the spindle drive under a reset force of a spring.

7. The locking device according to claim 2, wherein the pivotable locking catch is activatable by a locking bar that is displaceable on a linear path and associated with a control device.

8. The locking device according to claim 6,
wherein the pivotable locking catch includes a contact roller, which is arranged relative to the locking bar so that the contact roller is rollable along a sloped contact surface of the locking bar in order to actuate the pivotable locking catch.

9. The locking device according to claim 2, wherein the at least one contact damping element is fixed in a receiver of the pivotable locking catch.

10. The locking device according to claim 9, wherein the at least one contact damping element includes a mushroom head with a contact surface and a shaft, configured to fix the mushroom head in the receiver.

11. The locking device according to claim 9, wherein the at least one contact damping element is at least partially formed from an elastomeric material and/or a TPE material in an area of the mushroom head.

12. The locking device according to claim 9, wherein the at least one contact damping element is at least partially formed from a material in an area of the shaft that has a greater elasticity modulus than a material in an area of the mushroom head.

13. The locking device according to claim 6, wherein the locking device includes a component which includes the spring-loaded pin which is configured as the at least one contact damping element.

14. The locking device according to claim 4, wherein a pressure cavity is arranged adjacent to the spring-loaded pin, wherein a damping medium is arranged in the pressure cavity.

15. The locking device according to claim 6, wherein the spring-loaded pin includes a mushroom shaped bolt head at an end, the mushroom shaped bolt head including an end that tapers into a point and that includes a friction surface.

16. The locking device according to claim 2, wherein the pivotable locking catch includes a first lever arm actuated by the control device, and a second lever arm including a teething including at least one tooth configured to engage a corresponding teething of the spindle drive, wherein the first lever arm has a bending resistance in a range of 1×10⁻⁵ to 1×10⁻².

17. A brake actuator for a rail vehicle, the brake actuator comprising: a parking brake and a locking device configured to release the parking brake according to claim 1.

18. The brake actuator according to claim 17,
wherein the parking brake includes an axially movable service brake piston that is configured movable by pressure loading and coupled with a piston tube of the spindle drive,
wherein the piston tube engages a threaded nut of the spindle drive wherein the threaded nut is rotatably supported in a housing and includes the teething of the spindle drive,
wherein the locking device cooperates with the teething of the threaded nut through the pivotable locking catch,
wherein the pivotable locking catch is pivotable in a direction towards a surface of the housing of the brake actuator in order to release an engagement of the locking catch with the threaded nut.

19. The brake actuator according to claim 17, configured as a combination brake cylinder with a housing including
a service brake cylinder configured as an active service brake, including at least one pressure medium-actuated service brake piston that actuates a brake mechanism through a service brake piston rod, and
a spring accumulator brake cylinder configured as a passive parking brake which is releasable by the locking device and which is provided with a pressure medium-actuated spring accumulator brake piston, actuated against an effect of at least one accumulator spring, wherein the spring accumulator brake piston transmits a force of the at least one accumulator spring to the service brake piston rod when the parking brake is actuated.

20. The locking device according to claim 1, wherein the contact damping element is fixed in a wall of a housing of the brake actuator.
